(19) United States
(12) Patent Application Publication
(10) Pub. No.: US 2013/0205973 A1
(43) Pub. Date: Aug. 15, 2013

(54) KEYBOARD DEVICE FOR ELECTRONIC MUSICAL INSTRUMENT

(71) Applicant: Yamaha Corporation, (US)

(72) Inventors: Ichiro OSUGA, Hamamatsu-shi (JP); Kenichi NISHIDA, Hamamatsu-shi (JP); Shunsuke ICHIKI, Hamamatsu-shi (JP); Hiroshi HARIMOTO, Hamamatsu-shi (JP); Shin YAMAMOTO, Hamamatsu-shi (JP)

(73) Assignee: Yamaha Corporation, Hamamatsu-shi (JP)

(21) Appl. No.: 13/769,243

(22) Filed: Feb. 15, 2013

(30) Foreign Application Priority Data
Feb. 15, 2012 (JP) 2012-30414

(51) Int. Cl. G10H 1/34

(52) U.S. Cl. CPC G10H 1/344
USPC 84/433

(57) ABSTRACT

A keyboard device includes hammers 16w,16b that rock with the rocking movement of plural white and black keys 11w,11b. The plural white and black keys 11w,11b include drive units that drive the hammers 16w,16b. The drive unit is provided anterior or posterior to a front end of the key. A positional relationship between a plane including a key support portion of each white key 11w and black key 11b and the front end of the white key 11w and black key 11b, and a top face of each white key 11w and black key 11b is set such that the top faces of the plural white keys 11w and black key 11b are located on the same plane, when the rocking angles of the plural white keys 11w and black key 11b reach a predetermined angle respectively.

### BACKGROUND OF THE INVENTION

1. Field of the Invention

The present invention relates to a keyboard device for an electronic musical instrument such as an electronic organ, an electronic piano, and the like.

2. Description of the Related Art

There has conventionally been known a keyboard device for an electronic musical instrument described in Japanese Patent No. 3074794. In this keyboard device described above, a key touch feeling (reaction force against a key depression/release operation) on a front end of a key, to which a higher pitch is assigned, is set lighter in order to generate a key touch feeling similar to a key touch feeling of an acoustic piano. This keyboard device has plural hammers, each of which rocks through an engagement with the corresponding key so as to apply reaction force against the depression/release operation of the corresponding key. The plural hammers are common components. In this keyboard device, the length from the pivot point of the key, formed on a back end, to the front end of the key becomes gradually longer toward the keys on the high-pitched side from the keys on the low-pitched side. In addition, the position of the pivot point of each hammer is gradually shifted backward from the low-pitched side toward the high-pitched side, by which the distance from the pivot point of the key to the engagement position between the hammer and the key is set to be the same for all keys.

The conventional keyboard device described above has a stopper for restricting the rocking movement of the key, and the maximum depth during the key depression is the same for all keys. However, since the pivot point of each hammer is shifted in the longitudinal direction, the range of the rocking angle of each hammer is different among the assigned pitches. Therefore, it is necessary to set the position and performance of a rubber switch, which is pushed by the rocking movement of the hammer, to be different among the assigned pitches. In order that the height of the front end of each key and the tilt angle of each key during the key release and the key depression are set to be the same for all keys to make the appearance of the keyboard device similar to the appearance of an acoustic piano, the position and thickness of the stopper for restricting the rocking movement of each key have to be different among the assigned pitches. Accordingly, a large variety of components are needed, so that the productivity of the keyboard device is low.

### SUMMARY OF THE INVENTION

The present invention is accomplished to solve the above-mentioned problem, and aims to reduce cost for the keyboard device, which creates a key touch feeling and appearance similar to those of an acoustic piano by shifting the position of the pivot point of each key in the longitudinal direction, and to enhance productivity of the keyboard device. For easy understanding of the present invention, a numeral of a corresponding portion in an embodiment is written in a parenthesis in the description below of each constituent of the present invention. However, each constituent of the present invention should not be construed as being limited to the corresponding portion indicated by the numeral in the embodiment.

In order to attain the foregoing object, the present invention provides a keyboard device for an electronic musical instrument, the keyboard device including: plural white keys and black keys (11w, 11b) that are supported by a key support portion (Kw, Kb) in order that front ends thereof rock in the vertical direction by a key depression/release operation by a performer, each white key having an edge line extending in the longitudinal direction on a crossing portion of a side face and a top face, and each black key having an edge line extending in the longitudinal direction on a crossing portion of a lower side face and an upper side face tilting inward with respect to the lower side face, wherein a pitch is assigned to each of the plural white keys and black keys, each of plural white keys and each of black keys include an operation portion that is depressed and released by the performer, and a drive unit (11w1, 11b1) extending downward anterior or posterior to a front end of the operation portion, and a length from the front end of the operation portion to the key support portion is different among the plural white keys and black keys; plural hammers (16w, 16b), each of which includes an engagement portion engaged with the drive unit of each of the plural white keys and the drive unit of each of the plural black keys, and each of which is supported by a hammer support portion (Hw, Hb) in order to rock with the rocking movement of each of the plural white keys and black keys; and a restricting member (20, 21) that is arranged to extend in the direction of the arrangement of the plural white keys and black keys, and that restricts the rocking movement of the plural hammers in order to restrict the rocking range of the plural white keys and the plural black keys, wherein, when a first key out of the plural white keys and the plural black keys and a second key having the distance longer than the distance of the first key have a predetermined rocking angle respectively, the first key and the second key being both white keys or both black keys, a positional relationship between a plane including the key support portion of the first key and the front end of the operation portion of the first key, and the top face of the first key is set in order that the position of the front end of the operation portion of the first key in the vertical direction and in the longitudinal direction is the same as the position of the front end of the operation portion of the second key in the vertical direction and in the longitudinal direction, and the top face of the first key is in plane with the top face of the second key. In a state in which braking force for stopping the hammer by the restricting member is transmitted via the engagement portion between the key and the hammer, it is regarded that the rocking movement of the key is substantially restricted by the restricting member of the hammer.

In this case, it is preferable that the key support portion of the first key is located below a reference plane (S1, S3) including the key support portion of the second key and the front end of the second key in the state in which the second key is released, and when the first key and the second key are released, the front end of the operation portion of the first key is located in a plane (S2, D4) that includes the key support portion of the first key, and that crosses the reference plane on a portion closer to the drive unit of the second key than to the front end of the second key.

In this case, it is preferable that the first key and the second key are adjacent white keys, and the edge line of the black key between the first key and the second key is located between the top face of the first key and the top face of the second key, in a state in which the first key, the second key, and the black key are released.

In this case, it is preferable that the first key and the second key are adjacent white keys, and the edge line of the black key between the first key and the second key is located below the top face of the first key and the top face of the second key, in a state in which the first key, the second key, and the black key are depressed, and the rocking movements of the first key, the second key, and the black key are restricted. The state in which the rocking movement is restricted means the state in which the same load is applied to the front end of the white key and the front end of the black key to restrict the rocking movement of the keys. The present invention includes the case in which a part of the edge line of the black key on the front end is located below the top face of the first key and the top face of the second key.

In this case, it is preferable that the drive unit of each of the plural white keys is provided posterior to the front end of the operation portion, wherein the position of the front end of the operation portion in the key released state is higher in the white key, out of the plural white keys, having the shorter distance from the front end of the operation portion to the key support portion; and the drive unit of each of the plural black keys is provided anterior to the front end of the operation portion, wherein the position of the front end of the operation portion in the key released state is lower in the black key, out of the plural black keys, having the shorter distance from the front end of the operation portion to the key support portion.

In this case, it is preferable that the distance from the leading end to the hammer support portion of the plural hammers is the same for all of the plural hammers. Each of the plural hammers includes a mass member that becomes light from a low-pitched side toward a high-pitched side, and a key touch feeling becomes gradually light from the low-pitched side toward the high-pitched side. The mass member for the hammer for the white key is heavier than the mass member for the neighboring hammer for the black key. The length from the front end to the back end of the plural white keys becomes shorter toward the high-pitched side from the low-pitched side, and the length from the front end to the back end of the plural black keys becomes shorter toward the high-pitched side from the low-pitched side.

According to the keyboard device configured as described above, the appearance can be made close to the appearance of a keyboard on an acoustic piano without a need to adjust the height of the front end of the key for each key in the key released state and the key depression state. Therefore, the number of components can be reduced, compared to the case where the height of the front end of the key is adjusted for each key, whereby the cost for the keyboard device can be reduced. When the plural white keys and the black keys are depressed, and their rocking movement is restricted, in particular, the top face of the white key and the top face of the black key are located on the same plane, resulting in that the present invention can generate the appearance similar to the appearance of the acoustic piano in the key depression state. The rocking angle is an angle of the plane including the edge line of the key with the key released state being defined as a reference.

Another aspect of the present invention is that the distance between the plane including the edge line of the first key and the key support portion of the first key is set to be the same as the distance between the plane including the edge line of the second key and the key support portion of the second key. In this case, it is preferable that the positions of the key support portion of the first key and the key support portion of the second key are set to be the same. By virtue of this configuration, the part other than the part involved with the length of the key can be the same as much as possible. In addition, the support member (frame) for supporting the key can easily be designed. The support member is easily processed, whereby precision can be enhanced. When the distance between the plane including the edge line of the first key and the key support portion of the first key is set to be equal to the distance between the plane including the edge line of the second key and the key support portion of the second key, and the positions of the key support portion of the first key and the key support portion of the second key are set to be the same, the top face of the first key and the top face of the second key are located on the same horizontal plane in the key depression state. Consequently, the appearance similar to the keyboard of the acoustic piano can be generated.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a plan view illustrating a keyboard device according to one embodiment of the present invention;

FIG. 2 is a right side view illustrating a configuration of a white key in the keyboard device illustrated in FIG. 1;

FIG. 3 is a right side view illustrating a configuration of a black key in the keyboard device illustrated in FIG. 1;

FIG. 4 is a side view for describing a tilt angle of a top face of the white key;

FIG. 5 is a front view for describing a height of a front end of the key;

FIG. 6 is a side view for describing a tilt angle of a top face of the black key;

FIG. 7 is a graph of a characteristic curve illustrating a relationship between a pitch and a mass of a mass member; and

FIG. 8 is a graph of a characteristic curve illustrating a relationship between a pitch and a key touch.

### DESCRIPTION OF THE PREFERRED EMBODIMENT

One embodiment of the present invention will be described below with reference to the drawings. In the description below, a side close to a performer is defined as a “front side”, while a side far from the performer is defined as a “rear side”. A high-pitched side is defined as a “right side”, while a low-pitched side is defined as a “left side”.

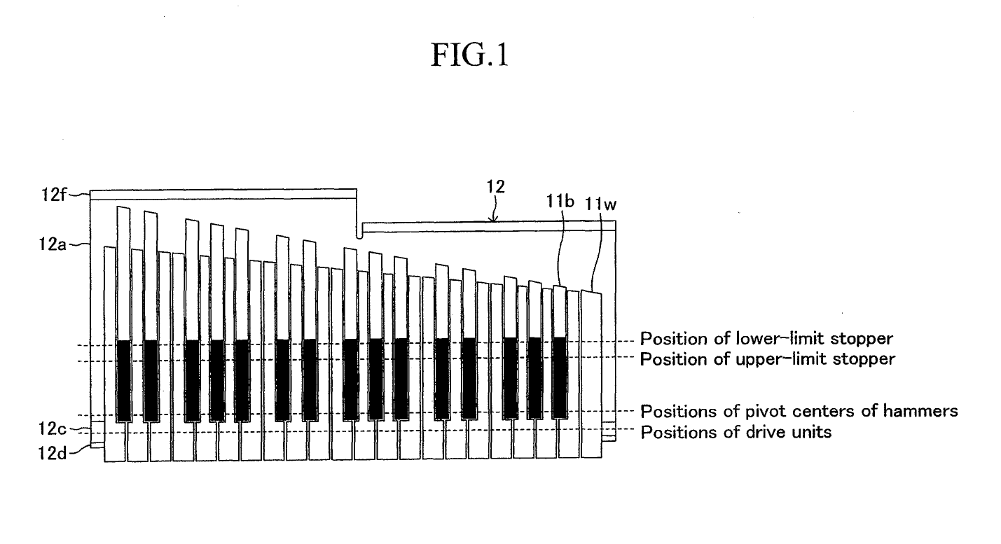

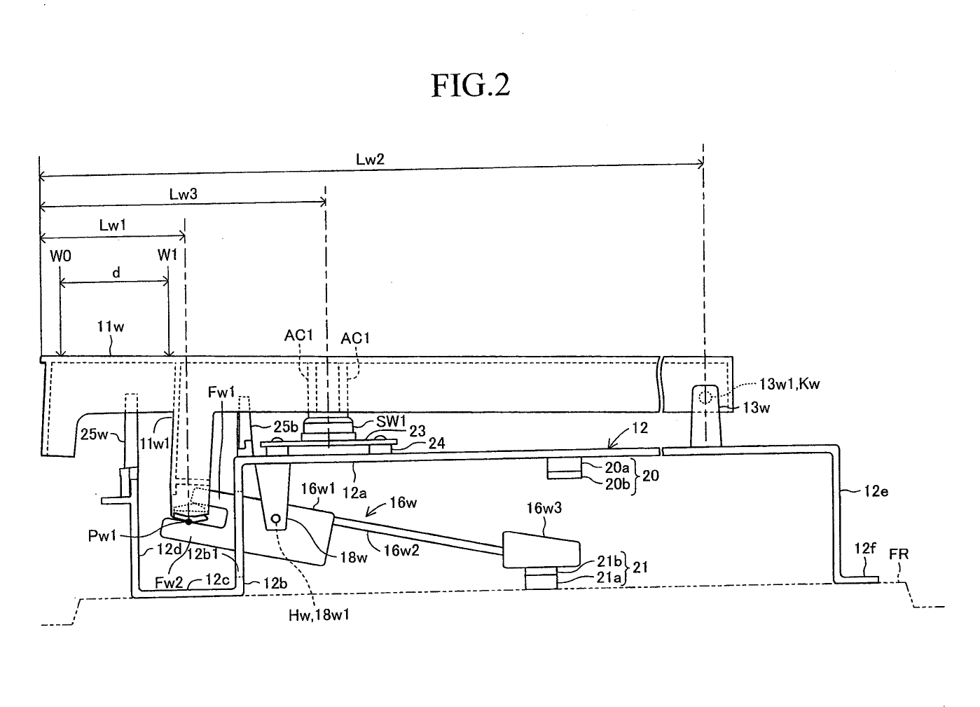

A keyboard device includes plural white keys 11w and plural black keys 11b as illustrated in FIGS. 1 to 3. A different pitch is assigned to each of plural white keys 11w and each of plural black keys 11b. In the present embodiment, one of “C3”, “D3”, . . . “C6” is assigned to the white keys 11w, while one of “C#3”, “D#3”, . . . “B#5” is assigned to the black keys 11b. The white keys 11w and black keys 11b are integrally formed to have a long shape by a synthetic resin. The white keys 11w are configured such that the length thereof is gradually shorter toward the white key 11w on the high-pitched side from the white key 11w on the low-pitched side. The black keys 11b are configured such that the length thereof is gradually shorter toward the black key 11b on the high-pitched side from the black key 11b on the low-pitched side. The back end of the black key 11b is located posterior to the back end of the adjacent white key 11w.

The white keys 11w, each having a different assigned pitch, have different length in the longitudinal direction, but the other structures are the same. The black keys 11b, each having a different assigned pitch, have different length in the longitudinal direction, but the other structures are the same. Each of the white keys 11w has a width in the vertical direction smaller than that of the black key 11b, and has a width in the lateral direction larger than that of the black key 11b. The white key 11w and the black key 11b have a hollow shape including a thin top wall extending in the longitudinal direction, and thin sidewalls extending downward from left and right ends of the top wall respectively, with no bottom.

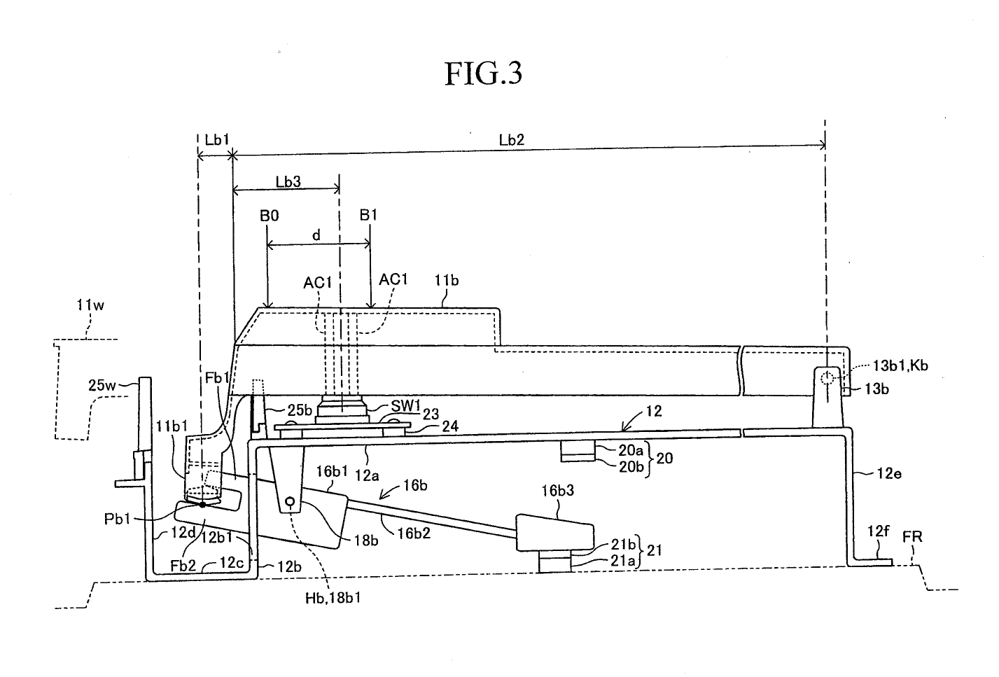

Through-holes Kw and Kb that are opposite to each other are formed on the rear part of the sidewall of the white key 11w and the black key 11b. The distance from the through-holes Kw and Kb to the back end of each key is the same for all keys. The white key 11w and the black key 11b are supported by a key support portion 13w and a key support portion 13b of a later-described key frame 12 with the through-holes Kw and Kb. The back end of the white key 11w goes into a casing of the electronic musical instrument, when the keyboard device is assembled to the electronic musical instrument. The portion of the white key anterior to the portion going into the casing is referred to as an apparent portion of the white key 11w. An edge line is formed on the portion where the side face and the top face of the white key 11w cross each other. The black key 11b has a portion projecting upward from the top face of the white key 11w in a state in which the black key 11b is not depressed, and the adjacent white keys 11w are not depressed. The projecting portion is referred to as an apparent portion of the black key 11b. The portion lower than the apparent portion of the black key 11b is referred to as a body. A performer depresses or releases the apparent portions of the white key 11w and the black key 11b. Specifically, the apparent portion corresponds to an operation portion in the present invention. The width of the apparent portion of the black key 11b in the lateral direction becomes narrower toward the top end, and the width of the body in the lateral direction is the same for all black keys. An edge line is formed on the boundary between the lower end of the apparent portion of the black key 11b and the portion lower than the lower end of the apparent portion (see FIG. 3).

The key frame 12 has a top plate 12a extending in the longitudinal direction and lateral direction. The position of the front end of the top plate 12a at the low-pitched side and the position of the front end at the high-pitched side are the same, but the back end at the low-pitched side is located posterior to the back end at the high-pitched side. The key frame 12 also has a front plate 12b vertically extending downward from the front end of the top plate 12a, a bottom plate 12c horizontally extending from the lower end of the front plate 12b, and a front plate 12d vertically extending upward from the front end of the bottom plate 12c. The key frame 12 also includes a rear plate 12e vertically extending downward from the back end of the top plate 12a, and a bottom plate 12f horizontally extending rearward from the lower end of the rear plate 12e. The height of the lower surface of the bottom plate 12c and the height of the lower surface of the bottom plate 12f are the same. The keyboard device is supported by a frame FR of an electronic musical instrument by the structure in which the lower surface of the bottom plate 12c and the lower surface of the bottom plate 12f are brought into contact with the frame FR of the electronic musical instrument and fixed thereto. The above-described key support portion 13w and the key support portion 13b are formed to project upward from the upper surface of the top plate 12a. The key support portion 13b is located posterior to the adjacent key support portion 13w. The key support portion 13w and the key support portion 13b respectively include two opposing plates, and a projection 13w1 and projection 13b1 that project inward. The projections 13w1 and 13b1 are fitted to the through-holes Kw and Kb respectively. Therefore, the white key 11w and the black key 11b are supported to be rotatable about the projections 13w1 and 13b1, and their front ends can rock in the vertical direction with the through-holes Kw and Kb and the center axes of the projections 13w1 and the projections 13b1 being defined as a pivot center. The distance between the top face of the apparent portion of the white key 11w (i.e., the plane including the right and left edge lines of the white key 11w) and its pivot center in the vertical direction is the same for all white keys 11w. The distance between the top face of the operation portion of the black key 11b (i.e., the plane including the right and left edge lines of the black key 11b) and its pivot center in the vertical direction is the same for all black keys 11b.

A drive unit 11w1 extends downward from the middle portion of the apparent portion of the white key 11w. The drive unit 11w1 has a hollow shape including a thin front wall extending in the vertical direction, and thin sidewalls extending rearward from left and right ends of the front wall, and is open to the rear. The lower end of the drive unit 11w1 is closed by a lower end wall. The length of the drive unit 11w1 in the vertical direction is the same for all white keys 11w. On the other hand, the black key 11w also has a drive unit 11b1 same as the drive unit 11w1 of the white key 11w. The drive unit 11b has a connection portion that extends downward from the front end of the apparent portion of the black key 11b and that is slightly curved to the front, and a vertical portion extending downward from the leading end of the connection portion. The configuration of the vertical portion is the same as that of the drive unit 11w1. The length of the drive unit 11b1 in the vertical direction is also the same for all black keys 11b.

A distance Lw1 from the front end of the white key 11w to the drive unit 11w1 in the longitudinal direction is within 30% of a distance Lw2 from the front end of the white key 11w with the highest pitch (i.e., the shortest key of the plural white keys 11w) to the through-hole Kw. The distance Lw1 is the same for all white keys 11w. A distance Lb1 from the front end of the apparent portion of the black key 11b to the drive unit 11b1 in the longitudinal direction is within 30% of a distance Lb2 from the front end of the apparent portion of the black key 11b with the highest pitch (e.g., the shortest key of the plural black keys 11b) to the through-hole Kb. The distance Lb1 is the same for all black keys 11b. The positions of the drive unit 11w1 and the drive unit 11b1 in the longitudinal direction are the same, and the positions of the lower end walls of the drive unit 11w1 and the drive unit 11b1 in the vertical direction are the same, when the white key 11w and the black key 11b are released. Specifically, the drive unit 11w1 and the drive unit 11b1 are located anterior to the front end of the apparent portion of the black key 11b, and the drive units 11w1 and the drive units 11b1 are arranged side by side in the lateral direction. In other words, the positions of the lower ends of the drive units 11w1 and the drive units 11b1 in the vertical direction and in the longitudinal direction are the same during the key release.

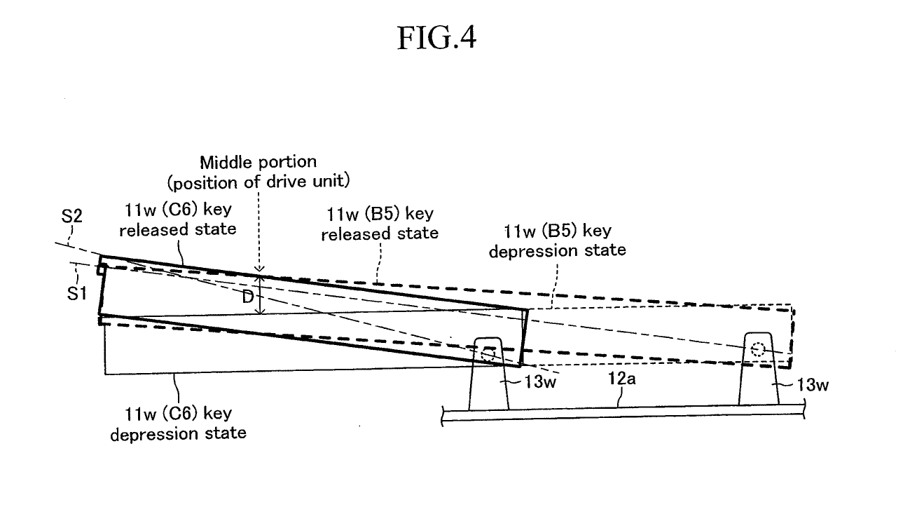

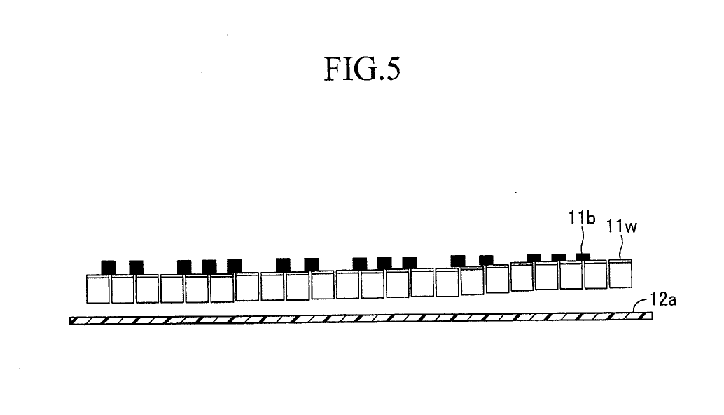

Since the length of the drive unit 11w1 in the vertical direction is the same for all white keys 11w, and the positions of the lower ends of the drive units 11w1 in the vertical direction and in the longitudinal direction are the same during the key release, the position of the top face in the middle of the white key 11w in the vertical direction and in the longitudinal direction during the key release is the same for all white keys 11w. As illustrated in FIG. 4, the white key 11w tilts such that the back end is lower than the front end during the key release, and the white keys 11w are configured such that the front end of the white key 11w having the shorter length in the longitudinal direction is higher. In the present embodiment, the length in the longitudinal direction becomes gradually shorter from the white key 11w on the low-pitched side toward the white key 11w on the high-pitched side. Therefore, as illustrated in FIG. 5, the front end of the white key 11w during the key release becomes gradually higher from the white key 11w on the low-pitched side toward the white key 11w on the high-pitched side. In a state in which two adjacent white keys 11w and the black key 11b between the two adjacent white keys 11w are released, the edge line R of the black key 11b is located below the top face of one on the low-pitched side of the two white keys 11w, and above the top face of one on the high-pitched side of the two white keys 11w.

In a state in which the white key 11w (C6) to which a pitch “C6” is assigned and the white key 11w (B5) to which a pitch “B5” is assigned are released, for example, the front end of the white key 11w (C6) is located slightly above the front end of the white key 11w (B5) (see FIG. 4). The pivot center of the white key 11w (C6) is located below a plane S1 including the pivot center of the white key 11w (B5) and the front end of the apparent portion of the white key 11w (B5) during the key release of the white key 11w (B5). Therefore, when the white key 11w (C6) and the white key 11w (B5) are released, the front end of the apparent portion of the white key 11w (C6) is located in a plane S2 that includes the pivot center of the white key 11w (B5) and that crosses the plane S1 on a portion closer to the drive unit 11w1 than to the front end of the apparent portion of the white key 11w (B5). FIG. 4 illustrates the posture when the white key 11w (B5) and the white key 11w (C6) are released and depressed. Specifically, the white key 11w (B5) that is released is indicated by a bold broken line, and the white key 11w (B5) that is depressed is indicated by a thin broken line. The white key 11w (C6) that is released is indicated by a bold solid line, and the white key 11w (C6) that is depressed is indicated by a thin solid line. In FIG. 4, the length of the white key 11w (C6) and the length of the white key 11w (B5) are greatly different in order to indicate the difference between the front ends of the apparent portions of the white keys 11w, each having a different length in the longitudinal direction. However, the difference between the lengths of the adjacent keys is actually small, so that the difference in height between the white keys 11w is also small. In FIG. 4, the shape of each key is simplified in order to simplify the drawing.

As described above, the tilt angle of the white key 11w having the shorter length in the longitudinal direction is larger in the key release state. The positional relationship between the plane including the pivot center and the front end of the apparent portion and the top face for each white key 11w is set such that the top faces of the plural white keys 11w are horizontal when the plural white keys 11w are depressed, and their rocking angles from the key release state reach the same predetermined rocking angle (i.e., when the hammer 13w is brought into contact with a buffer member 20b to restrict the rocking movement of the white key 11w as described later). In other words, the angle of the top face with respect to the plane including the pivot center and the front end of the apparent portion is set for each of the white keys 11w. The position of the front end of the apparent portion of the white key 11w in the vertical direction and in the longitudinal direction is the same for all white keys 11w in the state in which the top face of each of the plural white keys 11w is horizontal.

The length of the drive unit 11b1 in the vertical direction is the same for all black keys 11b, and the positions of the lower ends of the drive units 11b1 in the vertical direction and in the longitudinal direction are the same during the key release as described above. Therefore, in a state in which the black key 11b (G#5) to which a pitch “G#5” is assigned and the black key 11b (A#5) to which a pitch “A#5” is assigned are released, for example, the position of a crossing point PO of the axis of the drive unit 11b1 and the plane including the top face of the black key 11b in the vertical direction and in the longitudinal direction is the same for both keys. The black key 11b also tilts such that the back end is lower than the front end in the key released state, and the tilt angle of the key having the shorter length in the longitudinal direction is larger. Although the apparent portion of the white key 11w is located anterior to the drive unit 11w1, the front end of the apparent portion of the black key 11b is located posterior to the drive unit 11b1. Therefore, the front end of the apparent portion is lower in the shorter key. For example, in the state in which the black key 11b (G#5) and the black key 11b (A#5) are released, the front end of the apparent portion of the black key 11b (A#5) is lower than the front end of the apparent portion of the black key 11b (G#5). The pivot center of the black key 11b (A#5) is located below a plane S3 including the pivot center of the black key 11b (G#5) and the front end of the apparent portion of the black key 11b (G#5) during the key release of the black key 11b (G#5). When the black key 11b (G#5) and the black key 11b (A#5) are released, the front end of the apparent portion of the black key 11b (A#5) is located in a plane S4 that includes the pivot center of the black key 11b (A#5) and that crosses the plane S3 on a portion closer to the drive unit 11b1 than to the front end of the apparent portion of the black key 11b (G#5). In the present embodiment, the length in the longitudinal direction becomes gradually shorter from the black key 11b on the low-pitched side toward the black key 11b on the high-pitched side. Therefore, the front end during the key release becomes gradually lower from the black key 11b on the low-pitched side toward the black key 11b on the high-pitched side.

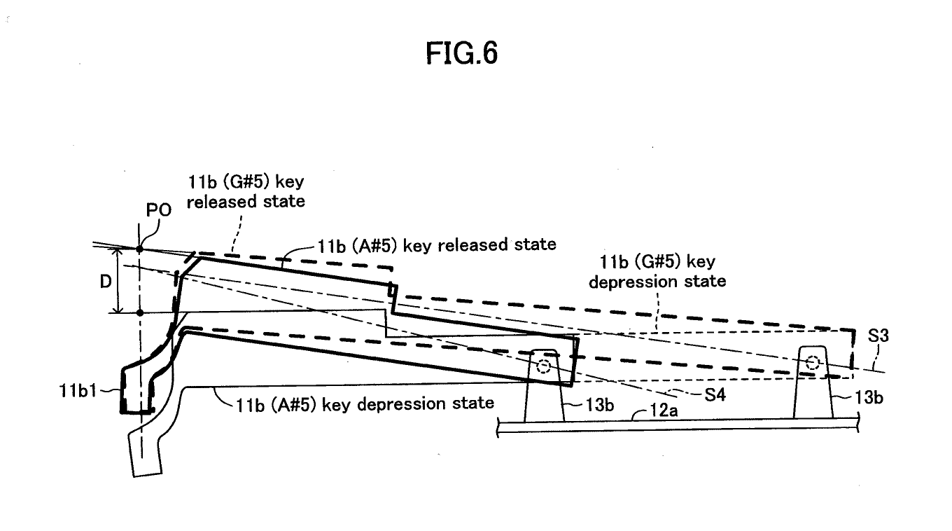

The positional relationship between the plane including the pivot center and the front end of the apparent portion and the top face for each black key 11b is set such that the top faces of the plural black keys 11b are horizontal when the plural black keys 11b are depressed, and their rocking angles from the key release state reach the same predetermined rocking angle (i.e., when the hammer 13b is brought into contact with a buffer member 21b to restrict the rocking movement of the black key 11b as described later). In other words, the angle of the top face with respect to the plane including the pivot center and the front end of the apparent portion is set for each of the black keys 11b. The position of the front end of the apparent portion of the black key 11b in the vertical direction and in the longitudinal direction is the same for all black keys 11b in the state in which the top face of each of the plural black keys 11b is horizontal. FIG. 6 illustrates the posture when the black key 11b (G#5) and the black key 11b (A#5) are released and depressed. Specifically, the black key 11b (G#5) that is released is indicated by a bold broken line, and the black key 11b (G#5) that is depressed is indicated by a thin broken line. The black key 11b (A#5) that is released is indicated by a bold solid line, and the black key 11b (A#5) that is depressed is indicated by a thin solid line. In FIG. 6, the length of the black key 11b (G#5) and the length of the black key 11b (A#5) are greatly different in order to indicate the difference between the front ends of the apparent portions of the black keys 11b, each having a different length in the longitudinal direction. However, the difference between the lengths of the adjacent keys is actually small, so that the difference in height between the black keys 11b is also small.

The lower ends of the drive unit 11w1 and the drive unit 11b1 are respectively engaged with front ends of hammers 16w and 16b in the opening formed between the front plate 12b and the front plate 12d. In the key released state, contact portions Pw1 and Pb1 between the lower ends of the drive unit 11w1 and the drive unit 11b1 and the front ends of the hammers 16w and 16b are located on the same straight line extending in the lateral direction (the direction parallel to the key arrangement direction).

The hammer 16w includes a base 16w1 made of synthetic resin, a connection rod 16w2 made of metal, and a mass member 16w3. Like the hammer 16w, the hammer 16b includes a base 16b1, a connection rod 16b2, and a mass member 16b3. The base 16w1 and the base 16b1 are plate-like members, and formed with through-holes Hw and Hb, respectively, from the right side face to the left side face. A hammer support portion 18w and a hammer support portion 18b are formed to project downward from the lower surface of the top plate 12a. The hammer support portions 18w and 18b are formed to have two opposing plates, and respectively have projections 18w1 and 18b1 projecting inward. The projections 18w1 and 18b1 are respectively fitted to the through-holes Hw and Hb. With this structure, the bases 16w1 and 16b1 are supported to be rotatable about the projections 18w1 and 18b1. Specifically, the hammer 16w and the hammer 16b are supported such that the front ends and the back ends can be rocked in the vertical direction. The positions of the hammer support portion 18w and the hammer support portion 18b in the longitudinal direction and in the vertical direction are the same for all hammers. Specifically, plural hammer support portions 18w and 18b are arranged side by side in the lateral direction, wherein the positions of the pivot center of the hammers 16w and 16b in the longitudinal direction and in the vertical direction are the same for all hammers 16w and 16b. In other words, the pivot centers of the hammers 16w and 16b are located on the same straight line extending in the lateral direction.

The base 16w1 includes a pair of leg portion Fw1 and leg portion Fw2 on its front end. The upper leg portion Fw1 is formed to be shorter than the lower leg portion Fw2. Like the base 16w1, the base 16b1 includes a pair of leg portion Fb1 and leg portion Fb2 on its front end. An elongated slit-like opening 12b1 extending in the vertical direction is formed on the front plate 12b for each of the hammers 16w and 16b. The front end of each hammer 16w and the front end of each hammer 16b project forward of the front plate 12b through the opening 12b1. The wall of the lower end of the drive unit 11w1 enters between the leg portions Fw1 and Fw2, while the wall of the lower end of the drive portion 11b1 enters between the leg portions Fb1 and Fb2. The leg portions Fw1 and Fb1 enter between the walls of the lower ends of the drive units 11w1 and 11b1 and intermediate walls that form gaps with the walls of the lower ends in the drive units 11w1 and 11b1. A shock absorbing material such as rubber, urethane, or felt is fitted and fixed on the wall of the lower end of each of the drive units 11w1 and 11b1. The shock absorbing material absorbs shock caused by the collision between the lower end of the drive unit 11w1 and the upper surface of the leg portion Fw2, the collision between the lower end of the drive unit 11b1 and the upper surface of the leg portion Fb2, the collision between the lower end of the drive unit 11w1 and the lower surface of the leg portion Fw1, and the collision between the lower end of the drive unit 11b1 and the lower surface of the leg portion Fb1.

The front end of the connection rod 16w2 and the front end of the connection rod 16b2 are assembled to the back end of the base 16w1 and the back end of the base 16b1, respectively. The connection rods 16w2 and 16b2 extend rearward. The position of the back end of the connection rod 16w2 and the position of the back end of the connection rod 16b2 in the longitudinal direction are the same. The mass member 16w3 and the mass member 16b3, described later, are assembled to the back end of the connection rod 16w2 and the back end of the connection rod 16b2, respectively.

As described above, the position of the pivot point of the key is different depending upon the assigned pitch. Therefore, the distance from the pivot center of the white key 11w to the contact portion Pw1 of the leg portion Fw2 and the drive unit 11w1 is different depending upon the assigned pitch. The distance from the pivot center of the black key 11b to the contact portion Pb1 of the leg portion Fb2 and the drive unit 11b1 is also different depending upon the assigned pitch. A key depression/release operation position W0 of the white key 11w that is the front end of the position of the white key 11w with the potentiality of being depressed or released is located anterior to the contact portion Pw1, while a key depression/release operation position B0 of the black key 11b that is the front end of the position of the black key 11b with the potentiality of being depressed or released is located posterior to the contact portion Pb1. Therefore, if the masses of the mass members for all hammers are equal, a key touch feeling is heavier on the middle-pitched part than on the low-pitched part, and the key touch feeling is heavier on the high-pitched part than on the middle-pitched part, on the key depression/release operation positions W0 and B0, because of the principle of leverage.

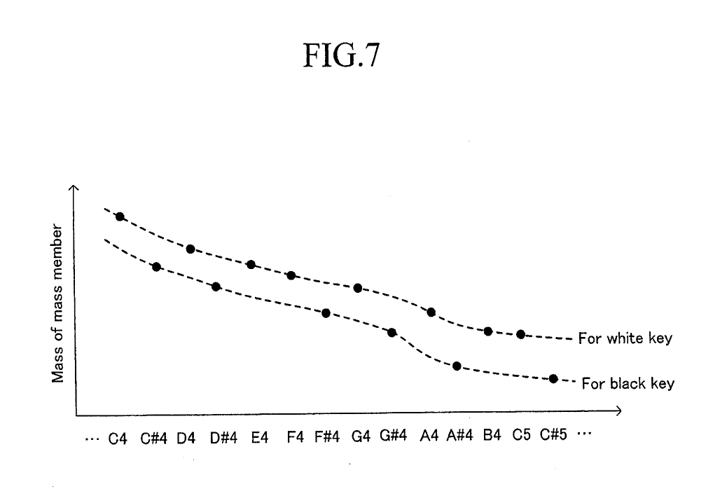

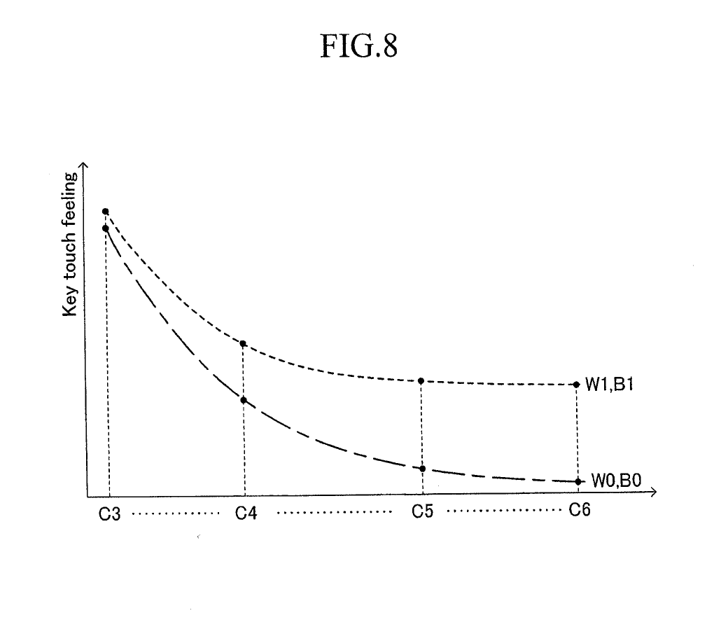

In addition, in this case, the key touch feeling of the white keys 11w and the black keys 11b in each range is not equal. Specifically, the key touch feeling of the key 11b is heavier than the key touch feeling of the adjacent two white keys 11w. In view of this, the mass of the mass member 16w3 and the mass of the mass member 16b3 are adjusted for each key as illustrated in FIG. 7. Specifically, as illustrated in a characteristic curve indicating the masses of the mass members 16w3 and 16b3 in the order of pitches, the masses of the mass members 16w3 and 16b3 are adjusted such that the characteristic curve of the mass member 16w3 and the characteristic curve of the mass member 16b3 are parallel downward-sloping curves, wherein the characteristic curve of the mass member 16b3 is located below the characteristic curve of the mass member 16w3. In other words, the mass member 16w3 for the white key 11w is heavier than the mass member 16b3 for the neighboring black key 11b. Thus, as illustrated by a chain line in FIG. 8, the key touch feeling on the key depression/release operation positions W0 and B0 becomes gradually lighter toward the high-pitched side from the low-pitched side. Therefore, as illustrated by a broken line in FIG. 8, the key touch feeling on key depression/release operation positions W1 and B1 located posterior to the key depression/release operation positions W0 and B0 by a distance d also becomes gradually lighter toward the high-pitched side from the low-pitched side. Since the length of the key to which a higher pitch is assigned is shorter, the difference between the key touch feeling on the key depression/release operation positions W0 and B0 and the key touch feeling on the key depression/release operation positions W1 and B1 becomes larger toward the high-pitched side from the low-pitched side. Specifically, the difference in the key touch feeling caused by the longitudinal difference of the key depression/release operation position is small on the low-pitched side, moderate in the middle-pitched side, and large on the high-pitched side.

When the white key 11w and the black key 11b are released, the front ends of the hammers 16w and 16b displace upward due to their own weight of the hammers 16w and 16b. In this case, the drive unit 11w1 and the drive unit 11b1 are biased upward by the leg portion Fw2 and the leg portion Fb2 respectively, whereby the front ends of the white key 11w and the black key 11b displace upward. On the other hand, when the white key 11w and the black key 11b are depressed, the lower surfaces of the drive unit 11w1 and the drive unit 11b1 press the upper surfaces of the leg portion Fw2 and the leg portion Fb2 respectively, whereby the front ends of the hammer 16w and the hammer 16b respectively displace downward.

A lower-limit stopper 20 is provided to the key frame 12. During the key depression, the lower-limit stopper 20 is brought into contact with the upper surfaces of the mass member 16w3 and the mass member 16b3 of the hammer 16w and the hammer 16b so as to restrict the upward displacement of the back ends of the hammer 16w and the hammer 16b, thereby restricting the downward displacement of the front ends of the white key 11w and the black key 11b. The lower-limit stopper 20 includes a stopper rail 20a and a buffer material 20b. The stopper rail 20a protrudes downward from the lower surface at the middle of the top plate 12a, and extends in the lateral direction. The stopper rail 20a is located above the mass member 16w3 and the mass member 16b3. The projection amount of the stopper rail 20a from the lower surface of the top plate 12a on the contact portion between the stopper rail 20a and each hammer is constant in the lateral direction. The buffer material 20b is fixed to the lower end surface of the stopper rail 20a. The buffer material 20b is a long member made of a shock-absorbing material such as rubber or felt. The sectional shape of the buffer material 20b is uniform from one end to the other end.

An upper-limit stopper 21 is provided to the middle portion of the frame FR. During the key release, the upper-limit stopper 21 is brought into contact with the lower surfaces of the mass member 16w1 and the mass member 16b1 of the hammer 16w and the hammer 16b so as to restrict the downward displacement of the back ends of the hammer 16w and the hammer 16b, thereby restricting the upward displacement of the front ends of the white key 11w and the black key 11b. Like the lower-limit stopper 20, the upper-limit stopper 21 includes a stopper rail 21a and a buffer material 21b. Specifically, the stopper rail 21a also extends in the lateral direction, and the projection amount thereof from the frame FR is constant in the lateral direction. The buffer material 21b is fixed on the upper surface of the stopper rail 21a. Like the buffer material 20b, the sectional shape of the buffer material 21b is uniform from one end to the other end. The stopper rail 20a and the stopper rail 21a may continuously extend in the lateral direction, or may discontinuously extend. The stopper rail 20a and the stopper rail 21a may be formed integral with the top plate 12a and the frame FR respectively, or may be formed as separate components and assembled to the top plate 12a and the frame FR respectively.

In the state in which the white key 11w and the black key 11b adjacent to the white key 11w are depressed respectively by the same depression force, and their rocking movement is restricted, the edge line R of the black key 11b is located below the top face of the white key 11w. The buffer member 20b and the buffer member 21b have elasticity. Therefore, when the key is depressed more after the hammer is brought into the buffer member during the key depression, the buffer member is elastically deformed, so that the front end of the key slightly displaces downward.

A switch drive unit AC1 is provided on the lower surface of each of the white key 11w and the black key 11b on the middle part. The switch drive unit AC1 is a plate-like member extending in the vertical direction in each of the white key 11w and the black key 11b, and the lower end surface of the switch drive unit AC1 is brought into contact with the upper surface of a switch SW1. The switch SW1 is provided for each key. The switch SW1 is pressed by the corresponding key to detect whether the corresponding key is depressed or released. Specifically, when the switch SW1 is depressed by the key, a rubber main body is deformed to make two contacts, which are formed on a circuit board 23, short-circuit, thereby being turned ON. The circuit board 23 extends in the lateral direction. A through-hole penetrating from the upper surface to the lower surface is formed on the circuit board 23. The through-hole corresponds to a boss 24 formed integral with the upper surface of the top plate 12a. When a screw is threaded to the boss 24 through the through-hole, the circuit board 23 is fixed to the key frame 12. The main bodies of the plural switches SW1, each corresponding to each key, are arranged on the upper surface of the circuit board 23 in the lateral direction. The position of the switch SW1 for the white key 11w and the position of the switch SW1 for the black key 11b in the longitudinal direction are the same. A distance Lw3 from the front end of the white key 11w to the switch SW1 in the longitudinal direction is within 30% of the distance Lw2 from the front end of the white key 11w with the highest pitch to the through-hole Kw, and a distance Lb3 from the front end of the apparent portion of the black key 11b to the switch SW1 is within 30% of the distance Lb2 from the front end of the apparent portion of the black key 11b with the highest pitch to the through-hole Kb. The switch SW1 for the white key 11w and the switch SW1 for the black key 11b may be arranged side by side in the lateral direction, and the positions of both switches in the longitudinal direction may be shifted.

A key guide 25w for guiding the rocking movement of the white key 11w is formed to project upward from the top end surface of the front plate 12d. The key guide 25w is inserted into the white key 11w from below, and during the key depression and key release, the side face of the key guide 25w and the inside face of the sidewall of the white key 11w are in sliding contact with each other. This structure can prevent a slight displacement of the white key 11w in the lateral direction during the key depression and key release.

A key guide 25b for guiding the rocking movement of the black key 11b is formed to project upward from the upper surface of the top plate 12a at the front end. The key guide 25b is inserted into the black key 11b from below, and during the key depression and key release, the side face of the key guide 25b and the inside face of the sidewall of the black key 11b are in sliding contact with each other. This structure can prevent a slight displacement of the black key 11b in the lateral direction during the key depression and key release.

In the keyboard device having the configuration described above, the appearance can be made close to the appearance of a keyboard on an acoustic piano without a need to adjust the height of the front end of the key for each key in the key released state and the key depression state. When the plural white keys 11w and the black keys 11b have the maximum depth during the key depression, the top faces of the white keys 11w and the black keys 11b are horizontal. Therefore, the appearance similar to the appearance of the acoustic piano in the key depression state can be created. Accordingly, the number of components can be reduced, compared to the case where the height of the front end of the key is adjusted for each key, whereby the cost for the keyboard device can be reduced. The front end of the white key 11w becomes gradually higher from the white key 11w on the low-pitched side toward the white key 11w on the high-pitched side during the key release, and the front end of the black key 11b becomes gradually lower from the black key 11b on the low-pitched side toward the black key 11b on the high-pitched side during the key release. Specifically, the difference in the height of the front end between the adjacent white keys 11w and between the adjacent black keys 11b is small in the key released state. Accordingly, the present embodiment can create comfortable appearance in the key released state.

The distance from the top face of the apparent portion of the white key 11w to the pivot center is the same for all white keys 11w, and the distance from the top face of the body of the black key 11b to the pivot center is the same for all black keys 11b. Accordingly, when the through-holes Kw and Kb are formed in a different process after a process of molding the outer shape of the white key 11w and the black key 11b, the different process can commonly be carried out for all keys to enhance productivity of the keys.

All components of the hammers 16w and 16b, except for the mass members 16w3 and 16b3, are the same for all hammers 16w and 16b. Accordingly, the variety of the components can be reduced, so that the cost for the keyboard device can be reduced. The positions of the pivot centers of the hammers in the longitudinal direction and in the vertical direction are the same for all hammers, and the positions of the upper-limit stopper 21 and the lower-limit stopper 20 in the longitudinal direction and in the vertical direction are the same for all hammers. Therefore, the upper-limit stopper 21 and the lower-limit stopper 20 can easily be assembled. The number of components can be reduced, compared to the case in which the stopper is provided for each hammer, resulting in that the cost for the keyboard device can be reduced. As described above, the positions of the pivot centers of the hammers and the positions of the upper-limit stopper 21 and the lower-limit stopper 20 in the longitudinal direction and in the vertical direction are the same for all hammers. Therefore, the ranges of the rocking angle of the hammers can be the same for all hammers.

In the present embodiment, when the white key 11w is assembled to the key frame 12, the wall of the lower end of the drive unit 11w1 has to be inserted between the leg portion Fw1 and the leg portion Fw2. When the black key 11b is assembled to the key frame 12, the wall of the lower end of the drive unit 11b1 has to be inserted between the leg portion Fb1 and the leg portion Fb2. In the present embodiment, the positions of the contact portions Pw1 and Pb1 in the longitudinal direction and in the vertical direction during the key release are the same for all keys and all hammers. With this structure, the walls of the lower ends of the drive units 11w1 for the plural white keys 11w and the drive units 11b1 for plural black keys 11b are easy to be simultaneously inserted between the leg portions. Specifically, plural keys can be assembled at a time, whereby an assembling property for assembling the keys to the key frame 12 can be enhanced.

Since the ranges of the rocking angles of the hammers are the same for all hammers, the rocking range D (see FIG. 4) of the top face at the middle of the white key 11w located above the drive unit 11w1 is the same for all white keys 11w. The rocking range D (see FIG. 6) of the crossing point PO located above the drive unit 11b1 of the black key 11b is the same for all black keys 11b. In the present embodiment, the distances Lw1 and Lb1 are set to be sufficiently smaller than the distances Lw2 and Lb2 respectively. Therefore, the maximum depth of the front end of the key during the key depression is almost the same for all keys. Accordingly, a performer is easy to play the keyboard device.

Plural switches SW1, each corresponding to each key, are arranged side by side in the lateral direction. The maximum depth of the front end of each key during the key depression is almost the same for all keys as described above. Therefore, if the switches SW1 are arranged side by side in the lateral direction near the front end of the key, the depth of the key during the key depression when the ON/OFF state of each switch SW1 is changed is almost the same. Therefore, this can realize that all switches SW1 have the same characteristics. Specifically, not only the variety of the components can be reduced to reduce the cost for the keyboard device, but also the key depression/release state of each key can be detected by the same process in the electronic musical instrument to which this keyboard device is applied. The circuit board 23 including the contacts of the plural switches SW1 is provided to extend in the lateral direction. Therefore, the assembling property for the assembling operation can be enhanced, compared to the case in which the switch SW1 is assembled for each key.

Upon embodying the present invention, the present invention is not limited to the above-described embodiment, and various modifications are possible without departing from the scope of the present invention.

For example, the drive unit 11b1 of the black key 11b is provided anterior to the front end of the apparent portion in the present embodiment. However, the drive unit 11b1 may be provided just below the front end of the apparent portion. In this case, the position of the front end of the apparent portion of the black key 11b in the vertical direction may be set to be the same for all of the plural black keys 11b when the plural black keys 11b are released. Like the white key 11w, the drive unit 11b1 may be provided posterior to the front end of the apparent portion. In this case, the front end of the apparent portion may gradually be lower from the black key 11b on the low-pitched side toward the black key 11b on the high-pitched side, when the plural black keys 11b are released.

For example, in the embodiment described above, the switches SW1 are provided posterior to the drive units 11w1 and 11b1 respectively. However, they may be provided anterior to the drive units 11w1 and 11b1. In this case, a horizontal portion extending forward or backward from the upper end of the front plate 12d may be provided, and the circuit board 23 may be mounted to the horizontal portion. The switch drive unit AC1 may be provided anterior to the drive units 11w1 and 11b1 and above the switch SW1. Even with this configuration, the effect same as that provided by the above-mentioned embodiment can be obtained. Instead of the switch SW1, or in addition to the switch SW1, an optical sensor, a magnetic sensor, a capacitance sensor, or a pressure-sensitive sensor may be used to detect whether the key is depressed or released.

In the present embodiment, the pivot centers of the hammers 16w and the hammers 16b are formed on the middle part of the respective hammers 16w and 16b, for example. The engagement portions between the white key 11w and the hammer 16w as well as between the black key 11b and the hammer 16b are formed on the front end of the hammer 16w and the front end of the hammer 16b, respectively. However, the pivot center of each hammer and the position of the engagement portion are not limited to those described in the above embodiment. For example, the pivot centers may be formed on the back end of the hammer 16w and the back end of the hammer 16b. The engagement portions may be formed on the middle part of the hammer 16w and on the middle part of the hammer 16b, and the mass member 16w3 and the mass member 16b3 may be mounted on the front end of the hammer 16w and the front end of the hammer 16b respectively. In this case, the front ends of the hammer 16w and the hammer 16b are biased upward by an elastic member such as a spring or rubber during the key release. In this case too, the pivot centers of the respective hammers and the engagement portions may be arranged side by side in the lateral direction, and the stopper for restricting the rocking movement of the hammers 16w and 16b may be arranged in the lateral direction. With the configuration in which the front ends of the hammers 16w and 16b rock in the vertical direction about the back ends of the hammers 16w and 16b as described above, the effect same as that of the above-mentioned embodiment can also be obtained.

For example, in the present embodiment, the mass member 16w3 and the mass member 16b3 are mounted to the back ends of the connection rod 16w2 and the connection rod 16b2. However, the mass member 16w3 and the mass member 16b3 are not mounted, but the leading ends of the connection rod 16w2 and the connection rod 16b2 may be folded back to the front so as to concentrate the mass on the back ends of the hammer 16w and the hammer 16b. By adjusting the length of the folded portion, the mass at the back ends of the hammer 16w and the hammer 16b may be adjusted.

In the embodiment described above and its modifications, the masses of the mass member 16w3 and the mass member 16b3 are adjusted to make the key touch feeling on the front end of the key gradually light toward the keys on the high-pitched side from the keys on the low-pitched side. However, the present invention is not necessarily configured as described above. The key touch feeling on the front end of the key in each range may be set to be the same, and the key touch feeling may be made light in a stepwise manner for each range toward the high-pitched range. It may also be configured such that the key touch feeling may become light in the order of pitches in only a certain range. Alternatively, it may be configured such that the key touch feeling may be set to be the same for all keys.

In the embodiment described above and its modifications, the length of the white key 11w becomes gradually shorter toward the white keys 11w on the high-pitched side from the white keys 11w on the low-pitched side, while the length of the black key 11b becomes gradually shorter toward the black keys 11b on the high-pitched side from the black keys 11b on the low-pitched side. However, the present invention is not necessarily configured as described above. The positions of the pivot centers of plural keys may be shifted in the longitudinal direction, and the positions of the respective portions for these keys may be set to be the same. For example, the whole range is divided into plural ranges, and the length of each of the keys belonging to each of the divided ranges may be set to be the same (i.e., the positions of the pivot centers of the keys in the longitudinal direction and in the vertical direction are set to be the same), while the length of the keys may be set to be different among the divided ranges. The positions of the respective portions in each of the divided plural ranges may be set to be the same. According to this configuration, the effect same as the above-mentioned embodiment can be obtained.

In the embodiment and its modification described above, the distance from the top face of the apparent portion of the white key 11w to its pivot center is the same for all white keys 11w. The distance from the top face of the body of the black key 11b to its pivot center is the same for all black keys 11b. The height of the pivot center is the same for all keys. However, the distance from the top face of the apparent portion of the white key 11w to its pivot center, the distance from the top face of the body of the black key 11b to its pivot center, and the height of the pivot center may be different for each key. Specifically, the distance from the top face of the apparent portion of the white key 11w to its pivot center, and the height of the pivot center may be set such that the top faces of the apparent portions of the plural white keys 11w are located on the same plane on any rocking position within the rocking range of the plural white keys 11w. The distance from the top face of the apparent portion of the black key 11b to its pivot center, and the height of the pivot center may be set such that the top faces of the apparent portions of the plural black keys 11b are located on the same plane on any rocking position within the rocking range of the plural black keys 11b.

The top faces of the white keys 11w during the key release may be located on the same plane, although this structure creates an appearance slightly different from the appearance of an acoustic piano. The top faces of the black keys 11b during the key release may be located on the same plane. In this case, when two keys having different length are compared, the pivot center of the shorter key may be located in the planes S1 and S3 (see FIGS. 4 and 6) of the longer key.

In the embodiment described above and its modifications, the length of each of the hammers in the longitudinal direction is set to be the same. However, the length of each of the hammers may be set to be gradually shorter toward the high-pitched side from the low-pitched side. In this case, the rate of change of the length of each hammer from the low-pitched side toward the high-pitched side may be set constant, and the lower-limit stopper 20 and the upper-limit stopper 21 on the high-pitched side may be arranged anterior to the lower-limit stopper 20 and the upper-limit stopper 21 on the low-pitched side. Specifically, the lower-limit stopper 20 and the upper-limit stopper 21 may be arranged diagonally, as viewed on a plane, in order that the ranges of the rocking angle of the hammers are the same for all hammers. With this structure, the number of components can be reduced, and the cost for the keyboard device can be reduced, compared to the case in which the stopper is provided for each hammer.

In the embodiment described above and its modifications, the white key 11w and the black key 11b are supported by the key support portions 13w and 13b of the key frame 12 by fitting the projections 13w1 and 13b1 to the through-holes Kw and Kb respectively so that the front ends of the white key 11w and the black key 11b can rock in the vertical direction. However, the white key 11w and the black key 11b can be mounted on the key frame 12 by using various supporting mechanisms, if the white key 11w and the black key 11b are supported by the key frame 12 so that the front ends of the white key 11w and the black key 11b can rock in vertical direction. For example, the rear ends of plural keys (the white key 11w and/or the black key 11b) may be are supported by the key frame 12 through elastic deformation members so that the front ends of the plural keys can rock in vertical direction. Concretely, the rear ends of the plural keys are connected to a fixing member fixed to the key frame 12 through thin and elastic connection members, wherein the fixing member is extended in the lateral direction, the connection members are extended horizontally or vertically, and the plural keys, the connection members and the fixing member are formed integrally. In this case, for example, the connection members for the white keys 11w are extended horizontally, and the connection members for the black keys 11b are extended vertically.

What is claimed is:

1. A keyboard device for an electronic musical instrument, the keyboard device comprising:
plural white keys and black keys that are supported by a key support portion in order that front ends thereof rock in the vertical direction by a key depression/release operation by a performer, each white key having an edge line extending in the longitudinal direction on a crossing portion of a side face and a top face, and each black key having an edge line extending in the longitudinal direction on a crossing portion of a lower side face and an upper side face tilting inward with respect to the lower side face, wherein a pitch is assigned to each of the plural white keys and black keys, each of plural white keys and each of black keys include an operation portion that is depressed and released by the performer, and a drive unit extending downward anterior or posterior to a front end of the operation portion, and a length from the front end of the operation portion to the key support portion is different among the plural white keys and black keys;
plural hammers, each of which includes an engagement portion engaged with the drive unit of each of the plural white keys and the drive unit of each of the plural black keys, and each of which is supported by a hammer support portion in order to rock with the rocking movement of each of the plural white keys and black keys; and
a restricting member that is arranged to extend in the direction of the arrangement of the plural white keys and black keys, and that restricts the rocking movement of the plural hammers in order to restrict the rocking range of the plural white keys and the plural black keys, wherein,
when a first key out of the plural white keys and the plural black keys and a second key having the distance longer than the distance of the first key have a predetermined rocking angle respectively, the first key and the second key being both white keys or both black keys, a positional relationship between a plane including the key support portion of the first key and the front end of the operation portion of the first key, and the top face of the first key is set in order that the position of the front end of the operation portion of the first key in the vertical direction and in the longitudinal direction is the same as the position of the front end of the operation portion of the second key in the vertical direction and in the longitudinal direction, and the top face of the first key is in plane with the top face of the second key.

2. The keyboard device according to claim 1, wherein
the key support portion of the first key is located below a reference plane including the key support portion of the second key and the front end of the second key in the state in which the second key is released, and
when the first key and the second key are released, the front end of the operation portion of the first key is located in a plane that includes the key support portion of the first key, and that crosses the reference plane on a portion closer to the drive unit of the second key than to the front end of the second key.

3. The keyboard device according to claim 1, wherein
the distance between the plane including the edge line of the first key and the key support portion of the first key is set to be the same as the distance between the plane including the edge line of the second key and the key support portion of the second key.

4. The keyboard device according to claim 1, wherein
the positions of the key support portions of the first key and the second key are set to be the same.

5. The keyboard device according to claim 1, wherein
the first key and the second key are adjacent white keys, and the edge line of the black key between the first key and the second key is located between the top face of the first key and the top face of the second key, in a state in which the first key, the second key, and the black key are released.

6. The keyboard device according to claim 1, wherein
the first key and the second key are adjacent white keys, and the edge line of the black key between the first key and the second key is located below the top face of the first key and the top face of the second key, in a state in which the first key, the second key, and the black key are depressed, and the rocking movements of the first key, the second key, and the black key are restricted.

7. The keyboard device according to claim 1, wherein
the drive unit of each of the plural white keys is provided posterior to the front end of the operation portion, wherein the position of the front end of the operation portion in the key released state is higher in the white key, out of the plural white keys, having the shorter distance from the front end of the operation portion to the key support portion; and
the drive unit of each of the plural black keys is provided anterior to the front end of the operation portion, wherein the position of the front end of the operation portion in the key released state is lower in the black key, out of the plural black keys, having the shorter distance from the front end of the operation portion to the key support portion.

8. The keyboard device according to claim 1, wherein
the distance from the leading end to the hammer support portion of the plural hammers is the same for all of the plural hammers.

9. The keyboard device according to claim 8, wherein
each of the plural hammers includes a mass member that becomes light from a low-pitched side toward a high-pitched side, and a key touch feeling becomes gradually light from the low-pitched side toward the high-pitched side.

10. The keyboard device according to claim 9, wherein
the mass member for the hammer for the white key in the plural hammers is heavier than the mass member for the neighboring hammer for the black key.

11. The keyboard device according to claim 1, wherein
the length from the front end to the back end of the plural white keys becomes shorter toward the high-pitched side from the low-pitched side, and the length from the front end to the back end of the plural black keys becomes shorter toward the high-pitched side from the low-pitched side.
